(19) United States
(12) Patent Application Publication
(10) Pub. No.: US 2021/0139187 A1
(43) Pub. Date: May 13, 2021

(54) Method and System for Novel Gift Wrapping

(71) Applicants: Abigail Noor Keady, Fairfax Station, VA (US); John P Keady, Fairfax Station, VA (US)

(72) Inventors: Abigail Noor Keady, Fairfax Station, VA (US); John P Keady, Fairfax Station, VA (US)

(21) Appl. No.: 17/105,507

(22) Filed: Nov. 26, 2020

Related U.S. Application Data
(63) Continuation-in-part of application No. 15/922,867, filed on Mar. 15, 2018.
(60) Provisional application No. 62/471,861, filed on Mar. 15, 2017.

(51) Int. Cl. B65D 5/42; B65D 5/52

(52) U.S. Cl. CPC B65D 5/4258; B65D 5/52

(57) ABSTRACT

At least one embodiment is directed to a packet that includes items to attach to a present/gift to form a new form factor, forming shapes such as an animal.

### CROSS-REFERENCE TO RELATED APPLICATIONS

This application is a continuation in part of and claims priority to U.S. patent application Ser. No. 15/922,867, filed 15 Mar. 2018, which is a nonprovisional application of and claims priority to U.S. provisional patent application No. 62/471,861 filed on 15 Mar. 2017, all of which are incorporated herein by reference in their entirety.

### FIELD OF THE INVENTION

The present invention relates to items and methods that can decorate a present or gift, and more particularly, though not exclusively, a set of items that a consumer can purchase that will adhere to presents to mimic some other form.

### BACKGROUND OF THE INVENTION

Gifts are often wrapped in wrapping paper and bows, and in some cases specialized wrapping paper (e.g., animal skin patterns).

### BRIEF DESCRIPTION OF THE DRAWINGS

Exemplary embodiments of present invention will become more fully understood from the detailed description and the accompanying drawings, wherein:

FIG. 1 illustrates a gift;

FIG. 2 illustrates a packet containing items in accordance with at least one exemplary embodiment;

FIG. 3 illustrates the items of FIG. 2 removed from the packet;

FIG. 4 illustrates the assembly of the items on the gift;

FIG. 5 illustrates a decorated present/gift in accordance with an exemplary embodiment;

FIG. 6 illustrates multiple gifts that can be accumulated into a combined decorated present in accordance with at least one exemplary embodiment;

FIG. 7 illustrates a packet containing items in accordance with at least one exemplary embodiment;

FIG. 8 illustrates the combined gifts of FIG. 6 decorated with items from the packet of FIG. 7;

FIG. 9 illustrates an additional packet containing items in accordance with at least one exemplary embodiment;

FIG. 10 illustrates the items from the packet in FIG. 9; and

FIG. 11 illustrates the items of packet FIG. 9 attached to various presents forming structures in accordance with at least one exemplary embodiment.

### DETAILED DESCRIPTION OF EMBODIMENTS

The following description of exemplary embodiment(s) is merely illustrative in nature and is in no way intended to limit the invention, its application, or uses. For example gifts can be attached to each other via various means, glue, tape, Velcro™, magnets (e.g., two magnets with sticky backs, each attached to an item or to a gift to attach items to gifts and/or gifts to gifts). In one non-limiting example a magnetic with a peal sticker is attached to its back, so that the magnet can be attached to one present and another to a second present. Then each of the two presents can be magnetically attached to each other. Likewise, an items can be attached to a gift/present. Additionally, the same attachment methods can be used to attach items (defined below) to the gifts.

‘Items’ refers to any item that can be attached to a present, e.g. tails, and can be formed of cloth, cotton, pipe cleaners, plastic, rubber, or other materials/methods; eyes formed of fuzzy cotton with black dots as pupils formed of plastic, cotton, cloth, and other craft or manufacturing materials as known by one of ordinary skill in crafts, special effects, plastic/rubber molding. The present application is not limited to any material forming the items. The items can be anything that changes the gift into a different form factor. For example, wings, eyes, windows, doors, etc . . .

The attached figures illustrate various methods and packets of items according to embodiments. Basically a gift's shape and form factor can be modified to mimic other shapes or form factors, or camouflage the gift, such as into animals, buildings, various patterns, cartoon characters, items such as books, shoes, food (e.g., cheese), scenes such as a mountain scene. The present application is not limited to how the gifts can be modified or combined to form or mimic other shapes.

FIG. 1 illustrates a gift 100, such as a wrapped present or just a bag or box.

FIG. 2 illustrates a packet 200 containing items in accordance with at least one exemplary embodiment. The packet 200 can contain multiple items that can be removed and attached to the gift forming a new shape/form (e.g., a bunny) modifying the form factor of the gift 100. For example the form/form factor can be, though not limited to, an animal (example dog, cat, bunny), building (e.g., bank, empire state building, church), vehicle (e.g., car, airplane, train, ship, spaceship, submarine), plant (e.g., corn, tree, hemp), hill, mountain, mythical creature (e.g., unicorn), cartoon character (e.g. woody woodpecker), fictional character (e.g., sherlock Holmes), historical scene (e.g., Columbus landing on shore), geological feature (e.g., devils tower), statue (e.g., statue of liberty), household item (e.g., toaster, cup), office item (e.g., stapler), scientific item (e.g., calculator, beaker), medical item (e.g., heart), academic item (e.g., diploma, cap,), judicial item (e.g., gavel), piece of clothing (e.g., boot, hat), historical person (e.g., Lincoln), historical item (e.g., arc of the covenant), books (e.g., moby dick), and fictional animal (e.g., dragon).

FIG. 3 illustrates the items of FIG. 2 removed 300 from the packet 370, where the items can include various items for example mouth 310, a first eye 320, a second eye 330, a bushy tail 340, a whisker 350, a first ear 360 and a second ear 370. Note items in the present application are not limited to animal parts, items can be anything that can change the gift into recognizable or fanciful patterns and shapes, even change the shape (e.g., into a ball).

FIG. 4 illustrates the attachment (410, 420, 430, 440, 450, 460, 470) of the items (310, 320, 330, 340, 350, 360, 370) respectively on the gift, changing the form factor changing the present, for example into a bunny (500, FIG. 5).

FIG. 5 illustrates a decorated present/gift in accordance with an exemplary embodiment, where the items of FIG. 4 have been attached to the present 100 forming a bunny 500. Note that attachment can be via various methods, for example tape, Velcro™

FIG. 6 illustrates multiple gifts (100, 110, 120, 130) that can be accumulated into a combined decorated present in accordance with at least one exemplary embodiment.

FIG. 7 illustrates a packet 700 containing items in accordance with at least one exemplary embodiment that can be used to combine presents into a shape. Note that the items can also contain magnets/Velcro™ with sticky backs that can be used to loosely or firmly attach the multiple gifts to each other after decorated.

FIG. 8 illustrates the combined gifts 800 of FIG. 6 decorated with items from the packet of FIG. 7 to form various shapes, for example a bunny, where each present forms parts of the bunny.

FIG. 9 illustrates an additional packet 900 containing items 1000 in accordance with at least one exemplary embodiment. For example the items can be used to combine each present into its own new shape (e.g., a building) where in combination the group of presents can form a village from the combination of the formed buildings. Other embodiments can form entire scenes, such as buildings, mountains, ships, balloons, trains, animals, etc . . .

FIG. 10 illustrates the items 1000 from the packet in FIG. 9. In the non-limiting example shown in FIG. 10, the items forms various components of buildings, for example doors, windows, roofs. Note that any material can be used, for example the windows can be paper stickers, or plastic molded models that can be attached, or even doors that can be opened.

FIG. 11 illustrates 1100 the items of packet FIG. 9 attached to various presents forming structures in accordance with at least one exemplary embodiment. In this example the combined presents/gifts form a little village of buildings.

In general the decoration can be anything that converts a gift into a form other than a box with wrapping paper and a bow.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments. For example, terms such as items, shapes, mimic, camouflage, are used, and their use herein , and the common English meaning, and any similar meaning from a thesaurus are included.

Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. A decoration comprising:
an item, where the item is configured to be attached to a gift; and
an attachment feature, where the attachment feature is configured to attach the item to the gift, where the item is configured to modify the shape of the gift to a form, where the form is at least one of an animal, building, vehicle, plant, hill, mountain, mythical creature, cartoon character, fictional character, historical scene, geological feature, statue, household item, office item, scientific item, medical item, academic item, judicial item, piece of clothing, historical person, historical item, book, and fictional animal.

2. The decoration according to claim 1 where the item is at least one of an arm, tail, eye, ear, mouth, window, door, chimney, roof, foot, and clothes.

3. The decoration according to claim 1 where the attachment feature is at least one of an adhesive, magnet, tape, and Velcro™.

4. The decoration according to claim 1 where the attachment feature is part of the item.

5. A form factor made of multiple gifts where multiple decorations according to claim 4 are attached to the multiple gifts.
